(19) United States
(12) Patent Application Publication
(10) Pub. No.: US 2026/0265535 A1
(43) Pub. Date: Sep. 10, 2026

(54) POLYMER COMPOSITION AND METHOD OF MAKING

(71) Applicant: DetraPel, Inc., Charlotte, NC (US)

(72) Inventors: Juan Jarufe, Charlotte, NC (US); Melissa Jarufe, Charlotte (NC); David Zamarin, Marvin, NC (US)

(73) Assignee: DetraPel, Inc., Charlotte, NC (US)

(21) Appl. No.: 19/162,622

(22) PCT Filed: Mar. 7, 2024
(86) PCT No.: PCT/US2024/018933

§ 371 Date: Sep. 5, 2025

Related U.S. Application Data
(60) Provisional application No. 63/450,598, filed on Mar. 7, 2023.

(51) Int. Cl. C09D 4/00; C09D 7/61; C09D 7/63

(52) U.S. Cl. CPC C09D 4/00; C09D 7/61; C09D 7/63

(57) ABSTRACT

A polymer composition comprising a first layer and a second layer. The first layer comprises an acrylic emulsion, a crosslinked silane, and polyvinylidene chloride. The second layer comprises an acrylic resin and a crosslinked silane. The polymer composition comprises a fluoride content of less than 10 parts per million. A method of making a polymer coating, the method comprising mixing compounds of a polymer, the compounds comprising a silane, an acrylic, and a clay. The method comprises applying a first layer of the mixture onto a surface, crosslinking the silane to form a polymer, and curing the polymer.

### CROSS-REFERENCE TO RELATED APPLICATIONS

This application claims priority to and the benefit of the filing of U.S. Provisional Patent Application No. 63/450,598, entitled “POLYMER COMPOSITION AND METHOD OF MAKING”, filed on Mar. 7, 2023, and the specification thereof is incorporated herein by reference.

### BACKGROUND OF THE INVENTION

### Field of the Invention

### Technical Field

The present invention relates to a polymer composition (hereinafter, polymer) and method of making the polymer coating.

### BACKGROUND

Polymers are often used as coatings to protect material or impart physical characteristics not inherent to that material. Cardboard and/or paper products are widely used in labeling, packaging, and printing but suffer from disadvantages including low durability and are susceptible to degradation following contact with water and/or oil. While polymer coatings are available that protect against water or oil damage, these polymer coatings are generally unable to be simultaneously protective against water and oil. Additionally, polymer coatings have limited longevity and cannot impart protective properties over long periods of time. For example, most polymer coatings degrade within a twelve-hour period. Polymers also degrade when subjected to bending and/or increased temperatures.

What is needed is a polymer able to coat cardboard and/or paper surfaces that is both hydrophobic and oleophobic and that is effective for long periods of time regardless of physical deformation or applied heat. This resistant polymer could then be applied to cardboard and/or paper as a protective coating.

### BRIEF SUMMARY OF THE INVENTION

Embodiments of the present invention relate to a composition comprising a composition comprising: a first layer comprising: an acrylic emulsion; a crosslinked silane; polyvinylidene chloride; a second layer comprising: an acrylic resin; a crosslinked silane; and said composition comprising a fluoride content of less than 10 parts per million. In another embodiment, the first layer further comprises a defoamer. In another embodiment, the defoamer of the first layer comprises an ester. In another embodiment, the second layer further comprises a defoamer. In another embodiment, the defoamer of the second layer comprises an ester. In another embodiment, the first layer further comprises a clay. In another embodiment, the clay of the first layer comprises a calcined clay. In another embodiment, the second layer further comprises a clay. In another embodiment, the clay of the second layer comprises a calcined clay.

In another embodiment, the first layer further comprises a pigment. In another embodiment, the pigment of the first layer comprises a calcined clay. In another embodiment, the pigment of the first layer is black. In another embodiment, the second layer further comprises a pigment. In another embodiment, the pigment of the second layer comprises a calcined clay. In another embodiment, the pigment of the second layer is black. In another embodiment, the polymer comprises a solids content of at least about 40%.

Embodiments of the present invention also relate to method of making a polymer coating, the method comprising: mixing compounds of a polymer to form a mixture, the compounds comprising: a silane; an acrylic; and a clay; applying a first layer of the mixture onto a surface; crosslinking the silane to form a polymer; and curing the polymer. In another embodiment, the method further comprises applying a second layer of the mixture onto the first layer of the mixture. In another embodiment, the curing is performed over of a period of time of 50 to 120 seconds. In another embodiment, the curing is performed at a temperature of 60° C. to 100° C.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a table showing polymer tests using a no. six wire rod with a cure of 80° C. for one minute according to an embodiment of the invention;

FIG. 2 is a table showing mixed polymer tests using a no. six wire rod with a cure of 80° C. for one minute according to an embodiment of the invention;

FIG. 3 is a table showing mixed polymer tests with added wax using a no. six wire rod with a cure of 80° C. for one minute according to an embodiment of the invention;

FIG. 4 is a table showing mixed polymer tests with added silane using a no. six wire rod with a cure of 80° C. according to an embodiment of the invention;

FIG. 5 is a table showing layered polymer tests using a no. six wire rod with a cure of 80° C. for one minute according to an embodiment of the invention;

FIG. 6 is a table showing layered polymer tests using a no. six wire rod at varying cure times and temperatures according to an embodiment of the invention;

FIG. 7 is a table showing polymer tests with various black pigments according to an embodiment of the invention;

FIG. 8 is a table showing polymer layer tests with various black pigments according to an embodiment of the invention;

FIG. 9 is a table showing polymer tests with various black pigments with added barrier material according to an embodiment of the invention;

FIG. 10 is a table showing polymer layer tests with various black pigments with added barrier material according to an embodiment of the invention;

FIG. 11 is a table showing polymer tests with various black pigments with added barrier material and reduced black pigment according to an embodiment of the invention;

FIG. 12 is a table showing polymer layer tests with various black pigments with added barrier material and reduced black pigment according to an embodiment of the invention;

FIG. 13 is a table showing polymer tests with various black pigment amounts according to an embodiment of the invention;

FIG. 14 is a table showing polymer layer tests with various black pigment amounts according to an embodiment of the invention;

FIG. 15 is a table showing polymer tests with various black pigments with varied dispersion types according to an embodiment of the invention;

FIG. 16 is a table showing polymer layer tests with various black pigments with varied dispersion types according to an embodiment of the invention;

FIG. 17 is a table showing polymer tests with a hybrid mixing method according to an embodiment of the invention;

FIG. 18 is a table showing polymer layer tests with a hybrid mixing method according to an embodiment of the invention;

FIG. 19 is a table showing polymer tests with reduced black pigment amounts according to an embodiment of the invention;

FIG. 20 is a table showing polymer layer tests with reduced black pigment amounts according to an embodiment of the invention;

FIG. 21 is a table showing polymer tests comparing polymers with a clear base, white pigment, and black pigment according to an embodiment of the invention;

FIG. 22 is a table showing polymer layer tests comparing polymers with a clear base, white pigment, and black pigment according to an embodiment of the invention; and

FIG. 23 is a diagram showing a polymer surrounding a pigment according to an embodiment of the invention.

### DETAILED DESCRIPTION OF THE INVENTION

Embodiments of the present invention relate to a polymer comprising: an acrylic emulsion; a copolymer emulsion; a copolymer resin; and a silane. The acrylic emulsion, copolymer emulsion, and/or copolymer resin may be water-based. The silane may be a functional silane, an epoxy silane, or a combination thereof. The polymer may comprise a plurality of layers. The polymer may comprise a first layer and a second layer. The first layer may comprise an acrylic emulsion; a copolymer emulsion; and a silane. The second layer may comprise a copolymer resin; a copolymer emulsion; and a silane.

The polymer may further comprise a pigment. The pigment may be black, white, or a combination thereof. The pigment may be embedded and/or interspersed between crosslinked polymer units.

Embodiments of the present invention also relate to a method of making a polymer coating, the method comprising: contacting an acrylic emulsion with a copolymer emulsion and/or copolymer resin and a silane to form a base; applying the base to a surface; crosslinking the silane, and curing the base. The method may further comprise contacting an acrylic emulsion with a copolymer emulsion, and a silane to form a first base; crosslinking the silane; applying the first base to a surface; curing the first base to form a first layer; contacting an acrylic emulsion with a copolymer resin and a silane to form a second base; crosslinking the silane; applying the second base to a surface; and curing the second base to form a second layer. The method may further comprise contacting the acrylic emulsion, the copolymer emulsion and/or copolymer resin and the silane with pigment. The pigment may be black or white. The pigment may be dispersed into the acrylic emulsion, copolymer emulsion, copolymer resin, and/or silane.

The polymer may be applied to cardboard and/or paper as a coating. The coating may be polymerized polymer. The polymer may not be absorbed or degrade as a result of direct food contact. The polymer may pass United States Food and Drug Administration compliance rules 176.170 and 176.180. When coated onto cardboard and/or paper the polymer may go from a freezer to an oven or a microwave without degrading.

The polymer may be oleophobic and/or resistant to oil and/or grease. The polymer may be resistance to all oils and/or greases including, but not limited to, canola oil, olive oil, vinegar, or a combination thereof. The polymer may be oleophobic and/or resistance to oil and/or grease (e.g., there should be no oil and/or grease staining of the surface) when applied as a coating to flat or creased surface. The polymer may be oleophobic and/or resistant to oil and/or grease for at least about 15 minutes to about 10 days, about 30 minutes to about 9 days, about 1 hour to about 8 days, about 4 hours to about 7 days, about 8 hours to about 6 days, about 12 hours to about 5 days, about 24 hours to about 4 days, about 2 days to about 3 days, or about 10 days.

The polymer may be hydrophobic and/or resistant to water. The polymer may be hydrophobic and/or resistant to water (e.g., there should be no water staining of the surface) when applied as a coating to flat or creased surface. The polymer may be oleophobic and/or resistance to oil and/or grease for at least about 15 minutes to about 10 days, about 30 minutes to about 9 days, about 1 hour to about 8 days, about 4 hours to about 7 days, about 8 hours to about 6 days, about 12 hours to about 5 days, about 24 hours to about 4 days, about 2 days to about 3 days, or about 10 days.

The polymer may repel grease according to Tappi standard T559. The polymer may have a Tappi standard T559 of 12 after at least about 5 minutes, about 5 minutes to about 1 hour, about 10 minutes to about 50 minutes, about 15 minutes to about 40 minutes, about 20 minutes to about 30 minutes, or about 1 hour of grease exposure.

The polymer may have heat sealing properties. The polymer may act as a heat seal for temperatures of at least about 50° C., about 50° C. to about 250° C., about 75° C. to about 225° C., about 100° C. to about 200° C. about 125° C. to about 175° C., or about 250° C. The polymer may act as a heat seal for pressures of at least about 10 pounds per square inch (psi), about 10 psi to about 60 psi, about 15 psi to about 55 psi, about 15 psi to about 50 psi, about 20 psi to about 45 psi, about 25 psi to about 40 psi, about 30 psi to about 35 psi, or about 60 psi. The polymer may act as a heat seal for a dwell time of at least 1 second.

The polymer may produce a surface tension of at least about 25 Dynes, about 25 Dynes to about 45 Dynes, about 30 Dynes to about 40 Dynes, or about 45 Dynes when coated onto a surface. The polymer have a moisture vapor transmission rate (MVTR) of less than about 8 grams/meter squared (g/m²), about 8 g/m² to about 0.5 g/m², about 7 g/m² to about 1 g/m², about 6 g/m² to about 2 g/m², or about 5 g/m² to about 3 g/m², or about 8 g/m² at about 38° C. and about 90% relative humidity (RH). The polymer may have a Cobb value of less than about 8 grams (g), about 8 g to about 0.5 g, about 7 g to about 1 g, about 6 g to about 2 g, about 5 g to about 3 g, or about 8 g after 30 minutes of water exposure.

The polymer coat may have liquid (e.g., water) blocking properties. The polymer coat may block a liquid weighing at least about 0.5 kg, about 0.5 kg to about 2.5 kg, about 1 kg to about 2 kg, or about 2.5 kg for at least about 4 hours, about 4 hours to about 36 hours, about 8 hours to about 24 hours, about 12 hours to about 18 hours, or about 36 hours at about 80% humidity and about 80 degrees Fahrenheit (° F.) when the liquid is disposed onto the polymer.

The polymer may be heat resistant. The polymer may exist at and/or tolerate temperatures at least about 200° F., about 200° F. to about 500° F., about 250° F. to about 450° F., about 300° F. to about 400° F., or about 500° F. for at least about 5 minutes, about 5 minutes to about 60 minutes, about 10 minutes to about 50 minutes, about 20 minutes to about 45 minutes, about 25 minutes to about 30 minutes, or about 60 minutes to about 60 minutes. The polymer may exist at and/or tolerate high power microwave exposure for at least about 1 minute, about 1 minute to about 15 minutes, about 2 minutes to about 14 minutes, about 4 minutes to about 12 minutes, about 6 minutes to about 10 minutes, or about 15 minutes.

The unit “Tg ° C.” as referenced herein means glass transition temperature. Glass transition temperature is the temperature at which polymers undergo a transition from a glassy to rubbery state. The unit “lbs” as referenced herein means pounds.

The term “oil/grease resistance—flat” as referenced herein means disposing oil and/or grease to a polymer coated onto a flat surface of coated cardboard or paper to determine penetration of the oil and/or grease onto the cardboard or paper after a given period of time.

The term “grease resistance—crease” as referenced herein means disposing oil and/or grease to a polymer coated onto a creased surface of coated cardboard or paper to determine penetration of the oil and/or grease onto the cardboard or paper after a given period of time.

The term “water resistance—flat” as referenced herein means disposing water to a polymer coated onto a flat surface of coated cardboard or paper to determine penetration of the oil and/or grease onto the cardboard or paper after a given period of time.

The term “water resistance—crease” as referenced herein means disposing water to a polymer coated onto a creased surface of coated cardboard or paper to determine penetration of the oil and/or grease onto the cardboard or paper after a given period of time.

The term “grease repellency” as referenced herein means the extent to which a polymer-coated surface is able to repel grease according to a Tappi standard T559 after about one hour of grease exposure.

The term “heat seal” as referenced herein means applying about 150° C. at about 40 psi to a polymer coated onto a surface to determine the heal sealing capacity of the polymer coating. The heat seal is determined by tearing the polymer-coated surface, with a severe tear indicating good heat sealing.

The term “blocking” as referenced herein means disposing water weighing about two kg onto a polymer-coated face of a two-sided surface for 24 hours at about 80% humidity, and about 80° F. to determine the penetration of water onto the surface.

The term “cook frozen to oven” as referenced herein means disposing frozen food onto a form tray coated with a polymer and cooking the food for 30 min at 425° F. in a convection oven to determine the penetration of the oil and/or grease onto the form tray after a given period of time.

The term “cook frozen to microwave” as referenced herein means disposing frozen food onto a form tray coated with a polymer and cooking the food for 10 minutes in a microwave set to a high-power setting to determine the penetration of the oil and/or grease onto the form tray after a given period of time.

The term “cook frozen to oven release” as referenced herein means disposing frozen food onto a form tray coated with a pigmented polymer and cooking the food for 30 min at 425° F. in a convection oven to determine the release of the cooked food from the polymer over a given period of time.

The term “cook frozen to microwave release” as referenced herein means disposing frozen food onto a form tray coated with a polymer and cooking the food for 10 minutes in a microwave set to a high-power setting to determine the release of the cooked food from the polymer over a given period of time.

The term “cook frozen to oven-color release” as referenced herein means disposing frozen food onto a form tray coated with a pigmented polymer and cooking the food for 30 min at 425° F. in a convection oven to determine the release of the cooked food from the polymer over a given period of time.

The term “cook frozen to microwave-color release” as referenced herein means disposing frozen food onto a form tray coated with a pigmented polymer and cooking the food for 10 minutes in a microwave set to a high power setting to determine the release of the cooked food from the polymer over a given period of time.

The term “printing” as referenced herein means contacting a surface coated with a polymer with a Dynes pen to determine the surface tension.

The term “COBB” as referenced herein means the Cobb value. The Cobb value is the amount of water that is taken up by a defined area of cartonboard through one-sided contact with water, within a certain amount of time.

The term “cure” as referenced herein means toughening or hardening of a polymer material by cross-linking of polymer chains, brought about by electron beams, heat or chemical additives.

The term “copolymer” as reference herein means a second polymer bonded to a first polymer.

As used herein, the compounds referenced by letters, for example, “A”, “B”, “C”, etc., comprise the chemical components as described in Table A below.

TABLE A

| Compound as it Appears in | |
|---|---|
| Application | Chemical Component |
| A | Acrylic emulsion |
| B | Copolymer emulsion |
| C | Film-forming acrylic |
| | emulsion |
| D | Copolymer resin |
| E | Non-film-forming acrylic |
| | emulsion |
| F | Non-ionic polypropylene |
| | wax |
| G | Ionic paraffin wax |
| H | Non-ionic paraffin wax |
| I | Monomeric |
| | alkylalkoxysilane |
| J | Epoxy silane |
| K | Epoxy silane oligomer |
| L | Alkoxysilane |
| M | Polymer defoamer |
| N | Succinic acid and ester |
| O | Polyether |
| P | Carbon black |
| Q | Carbon black |
| R | Carbon black |
| S | Organic pigment |
| T | Anhydrous Water Wash |
| | Clay |
| U | Anhydrous dry clay |
| V | Calcined clay |
| W | Muscovite |
| X | Titanium dioxide |
| Y | Anionic polymer emulsion |
| Z | Aqueous anionic |
| | copolymer emulsion |
| AA | Aqueous anionic |
| | copolymer emulsion |
| BB | Acrylic copolymer latex |

As used herein, the terms “Good”, “Fair”, “Pass”, and “Fail” are used in the specification to refer to degrees of quality for a given characteristic. For example, a Heat Seal of “Pass” indicates that the Heat Seal characteristic of a particular combination is above the desired requirements for that characteristic, e.g., that the Heat Seal meats the minimum required heat-sealing ability for the polymer. The terms of quality in declining quality ranking are as follows: Good, Fair, and Fail; or Pass and Fail. Quality terms follow by a number of days, for example “Pass 7 Days” mean that the combination met the requirements for that characteristic over the time period of seven days.

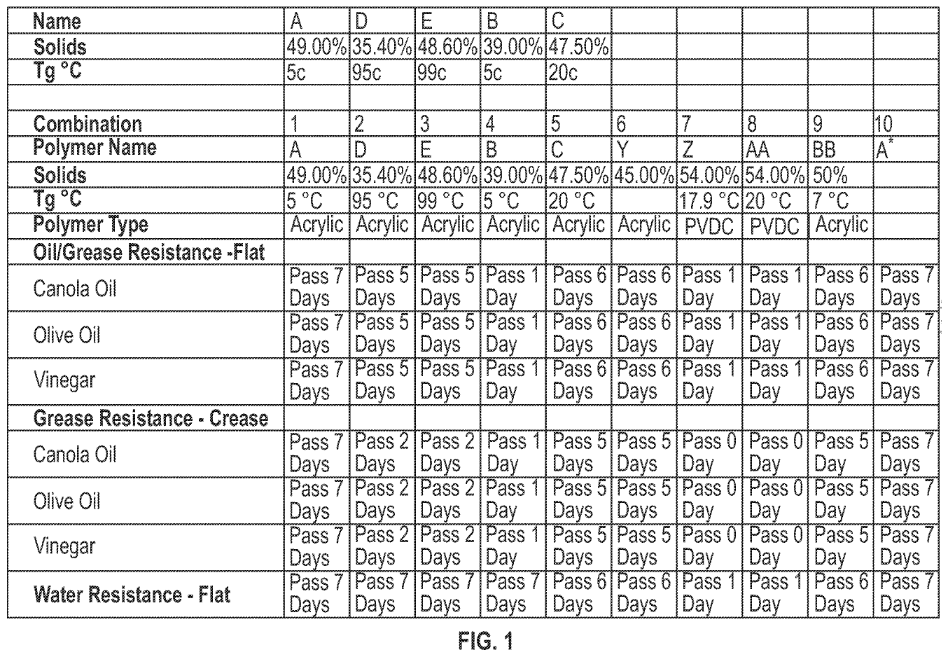

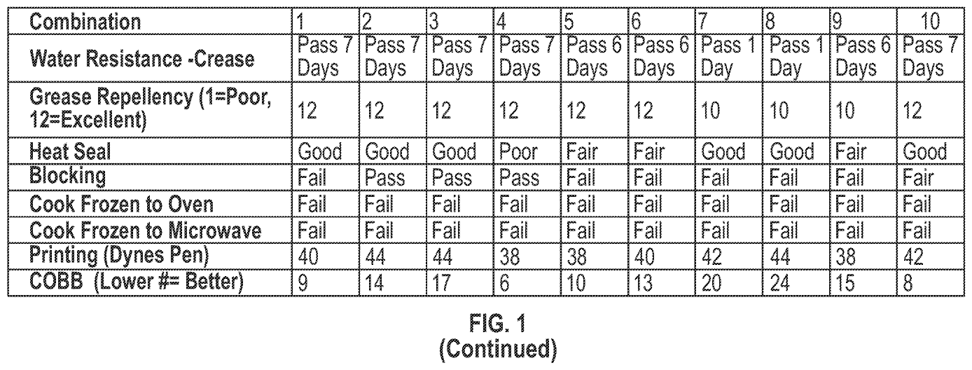

Turning now to the drawings, FIG. 1 shows polymer tests using a no. six wire rod with a cure of 80° C. for one minute. Polymers A, B, D, and E demonstrated the best results.

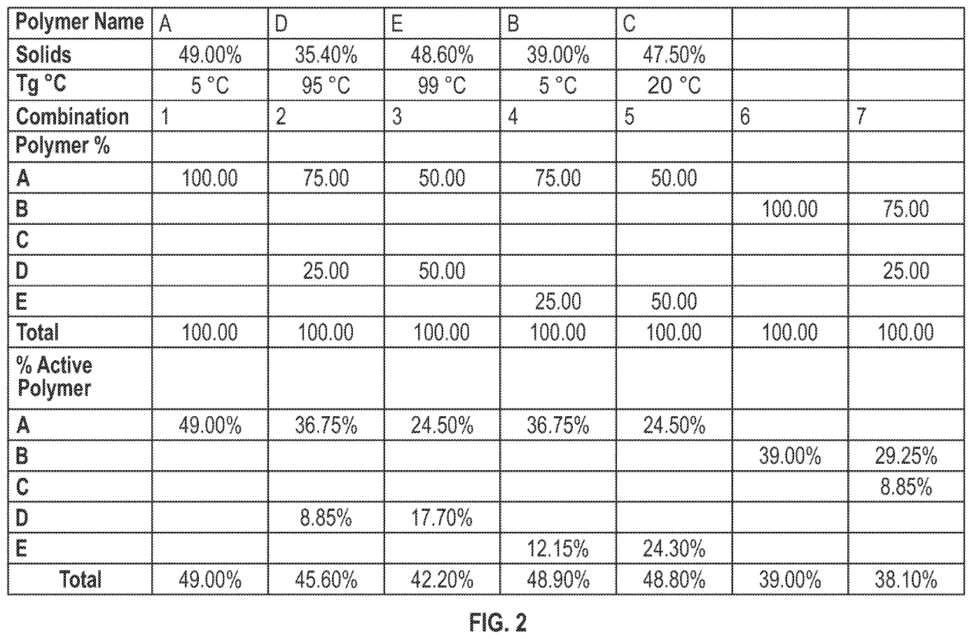

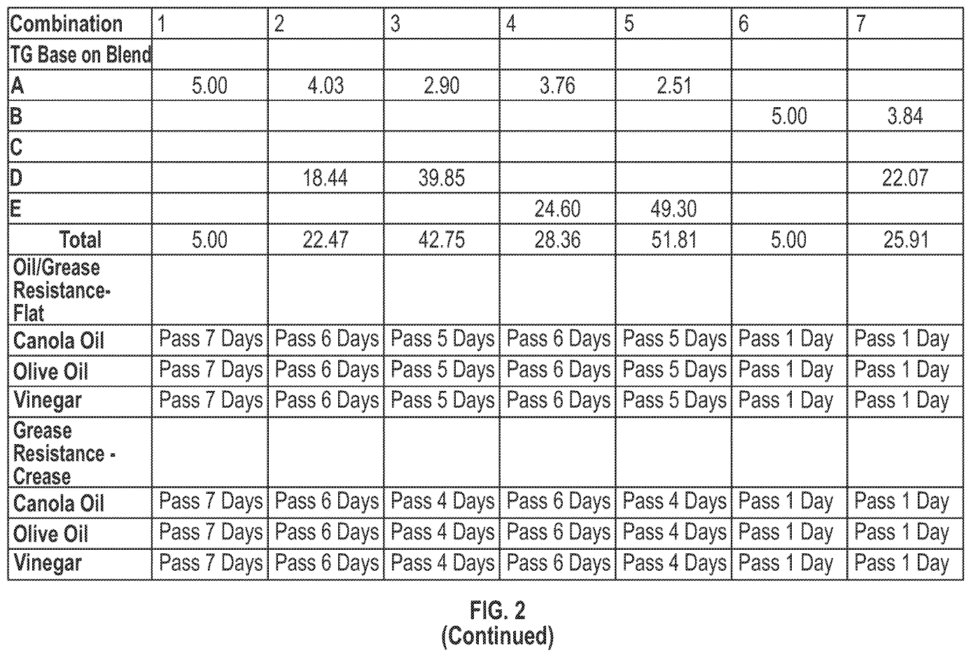

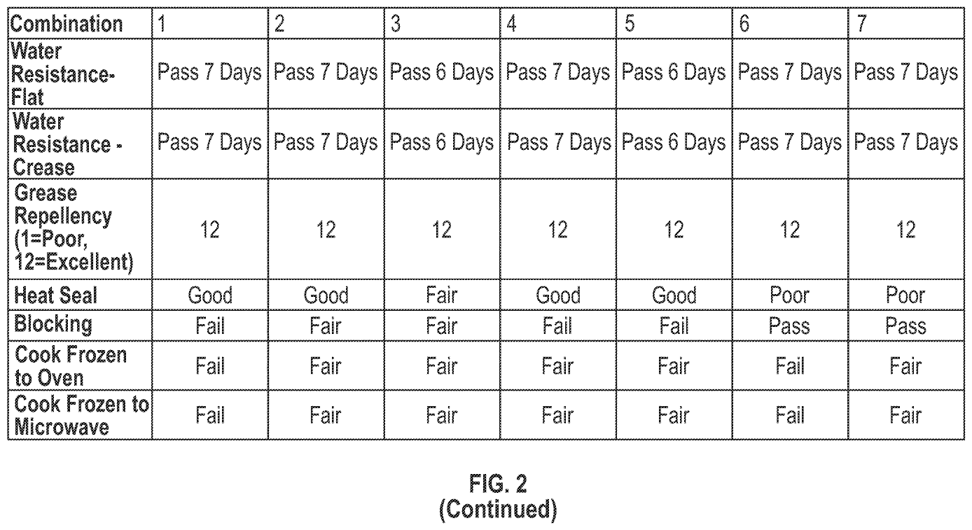

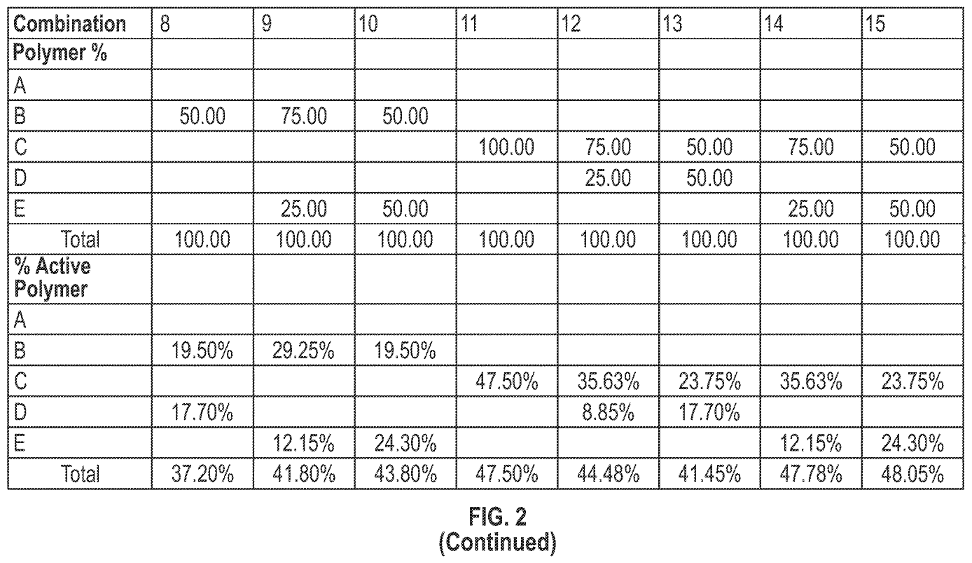

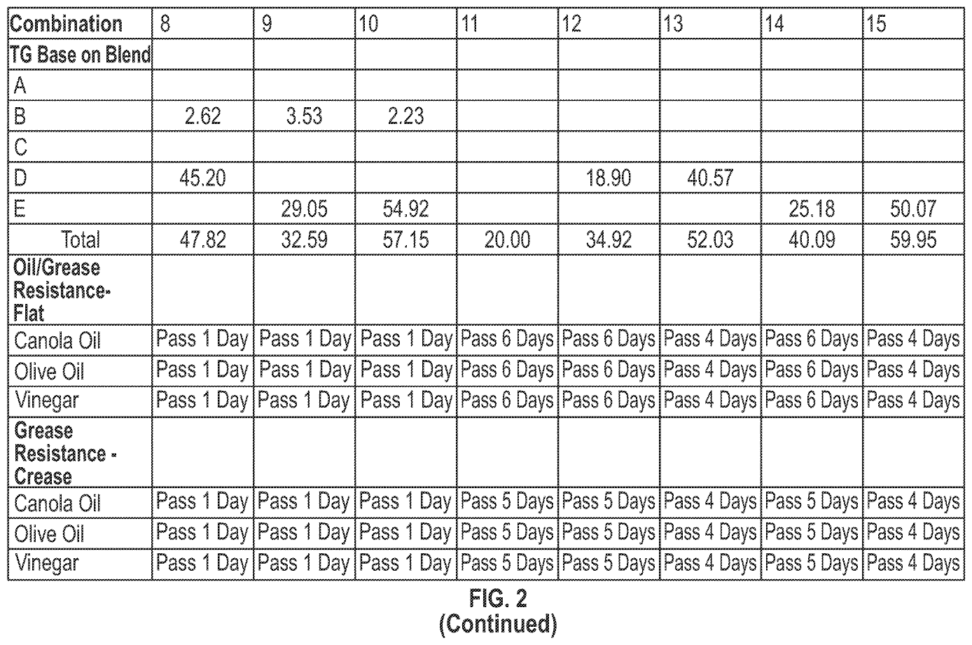

FIG. 2 shows mixed polymer tests using a no. six wire rod with a cure of 80° C. for one minute. Mixtures of compound A with compound D, and compound B with compound E produce the best results with a clear film.

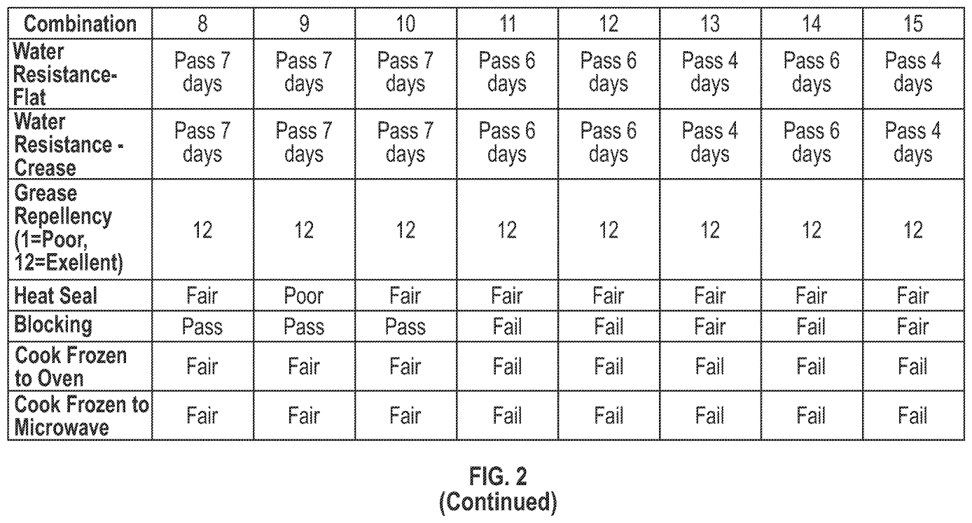

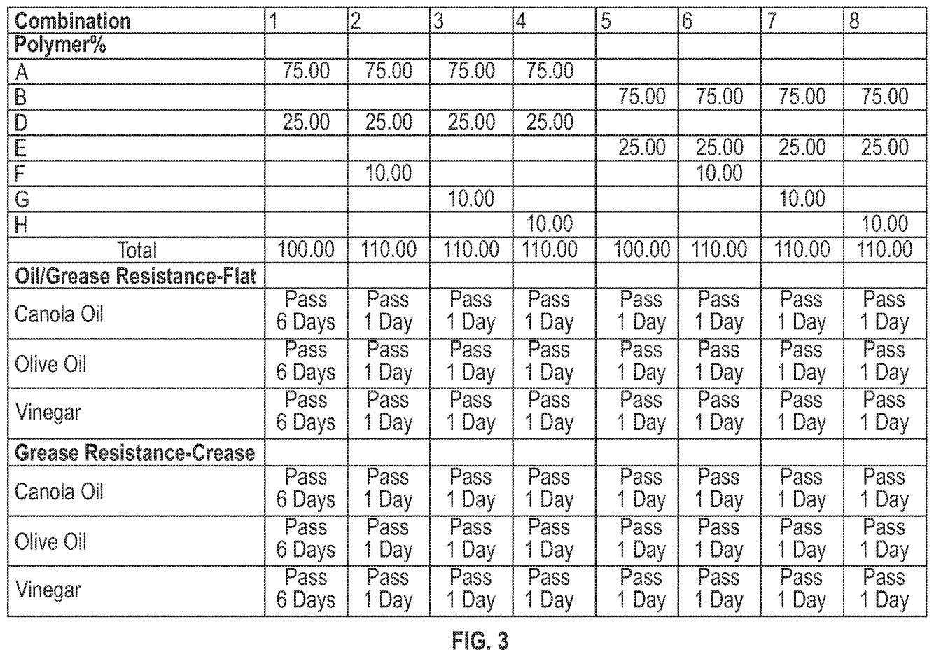

FIG. 3 shows mixed polymer tests with added wax using a no. six wire rod with a cure of 80° C. for one minute. Waxes reduce oil and/or grease resistance and/or repellency as well as cooking performance. However, added waxes improve blocking ability.

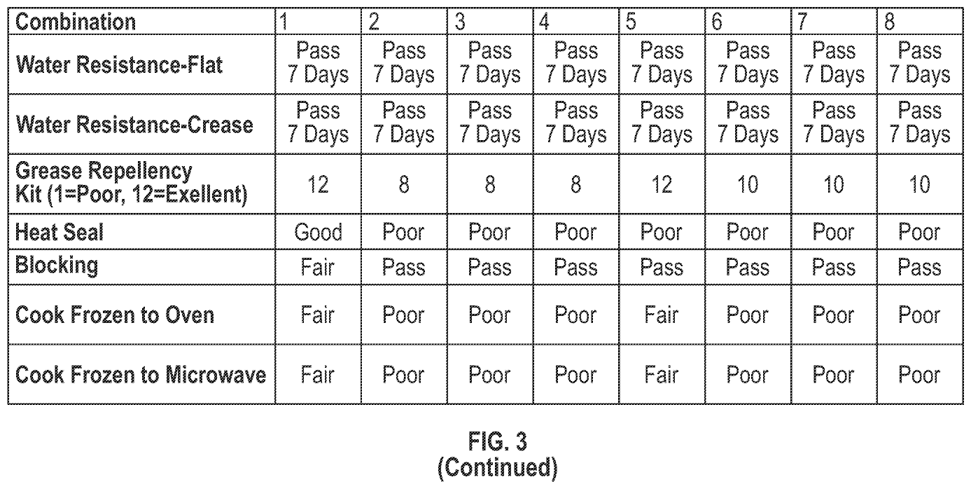

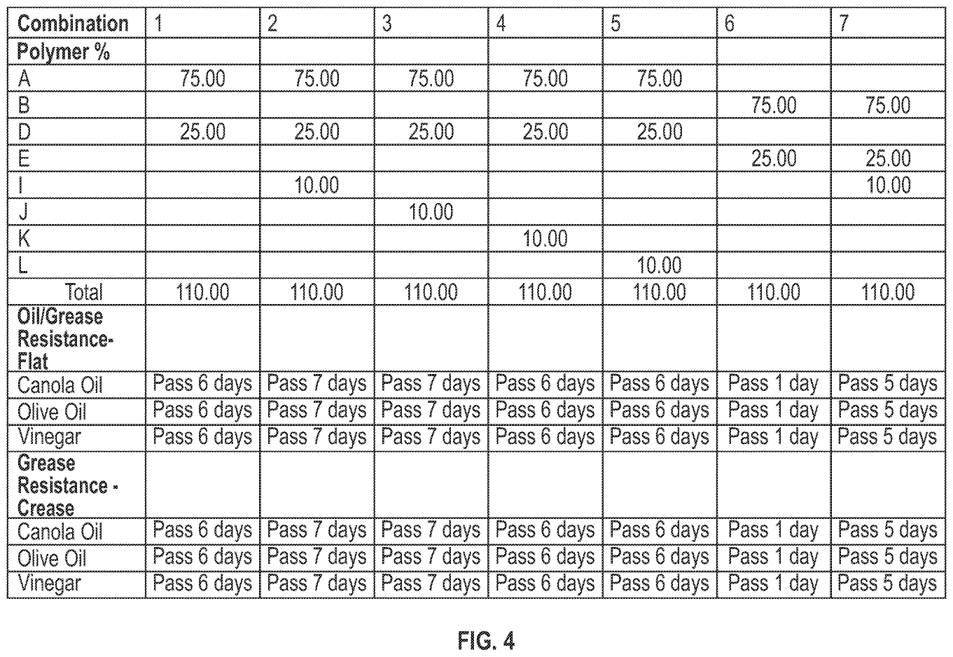

FIG. 4 shows mixed polymer tests with added silane using a no. six wire rod with a cure of 80° C. Combinations three and eight comprising compound J shows the best results.

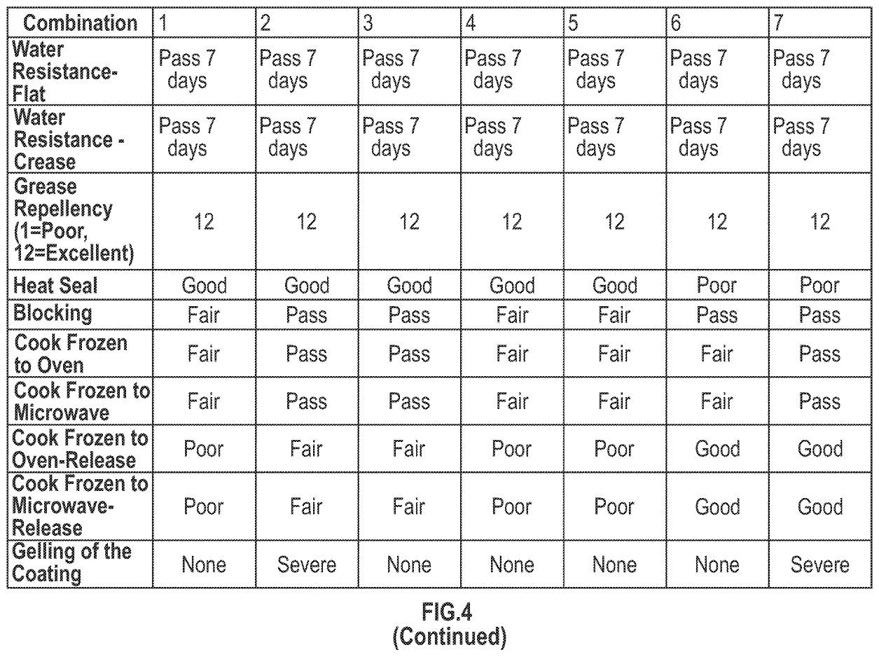

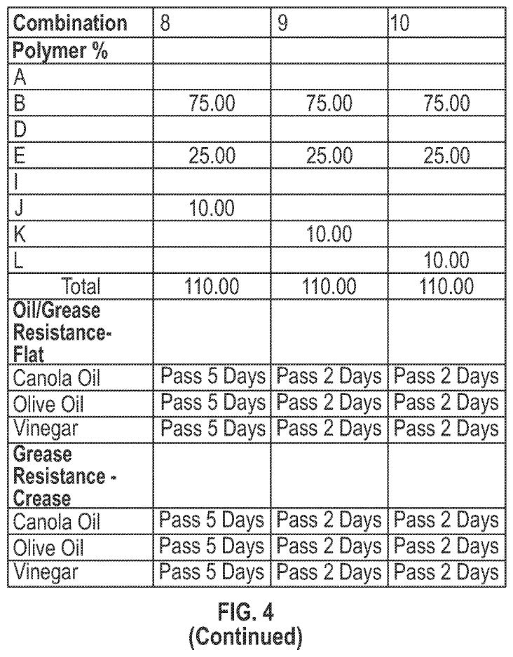

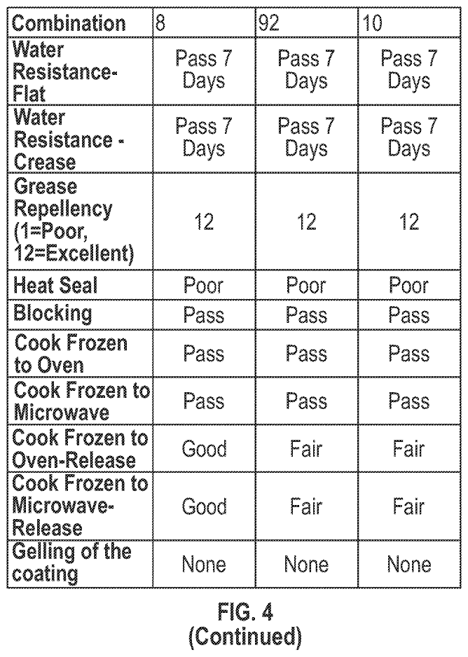

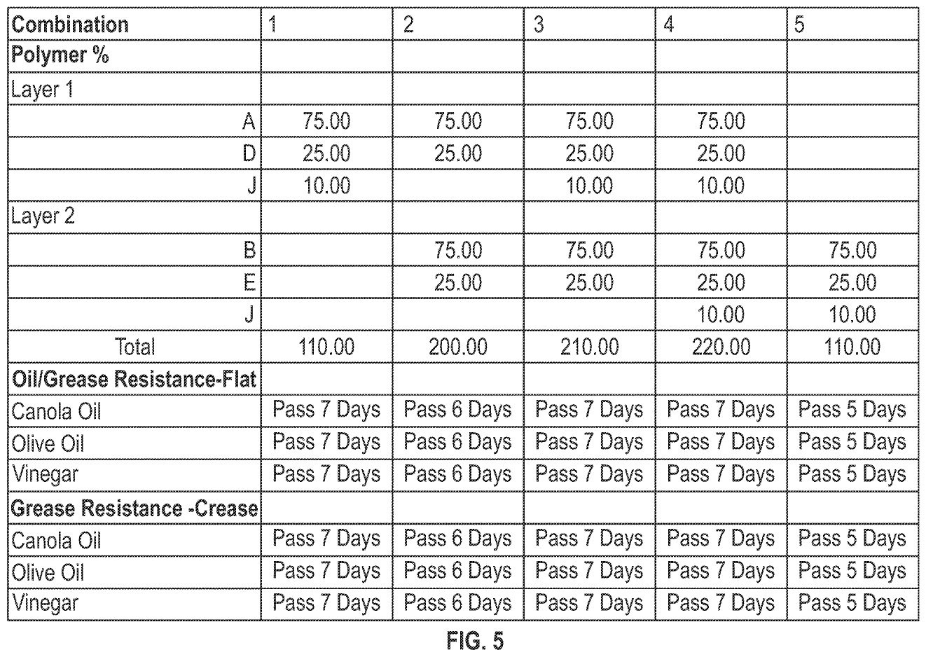

FIG. 5 shows layered polymer tests using a no. six wire rod with a cure of 80° C. for one minute. Combination four yields the best results.

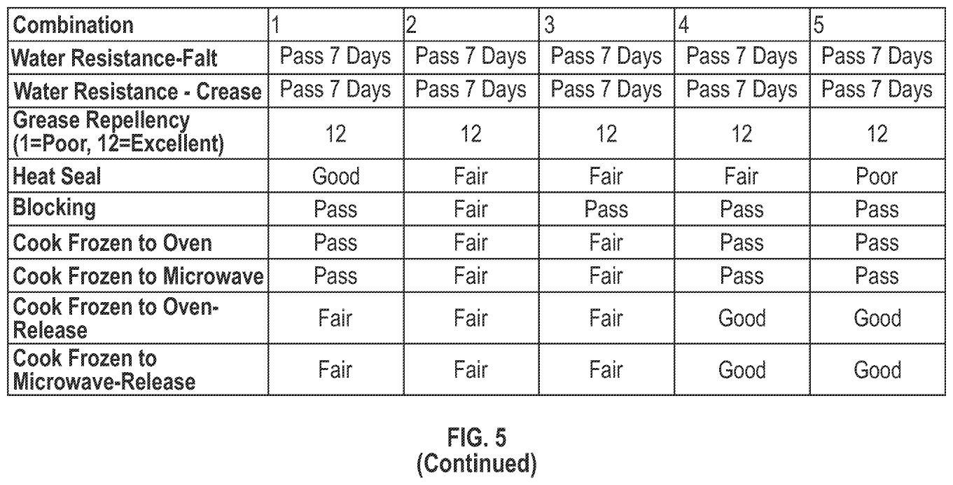

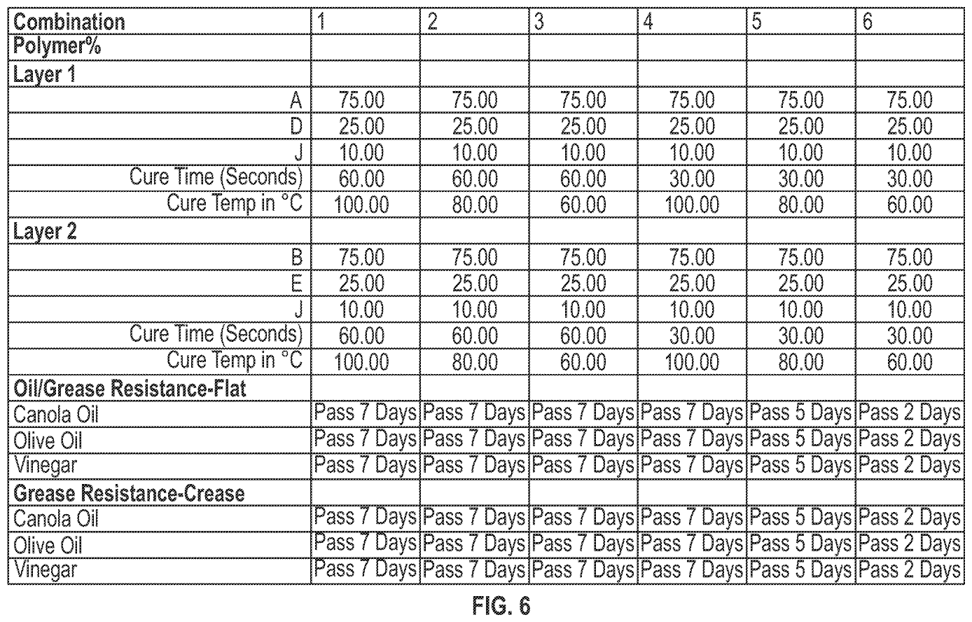

FIG. 6 shows layered polymer tests using a no. six wire rod at varying cure times and temperatures. The overall best cure combinations are cure times of 60 seconds at 100° C., 80° C., and 60° C.; and 30 seconds at 100° C.

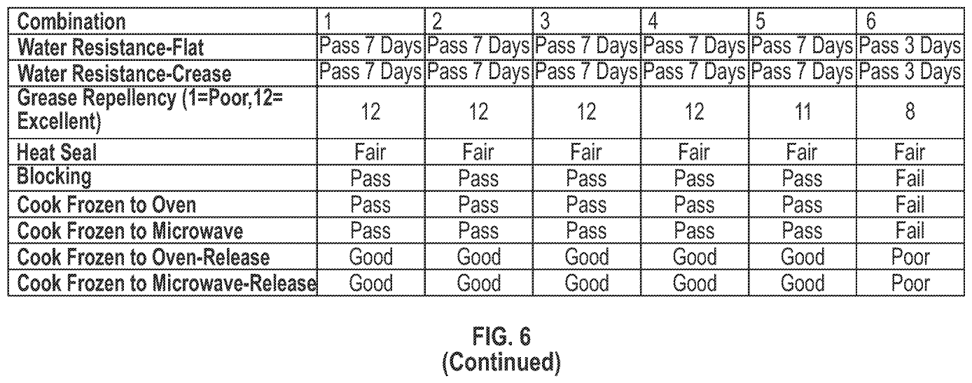

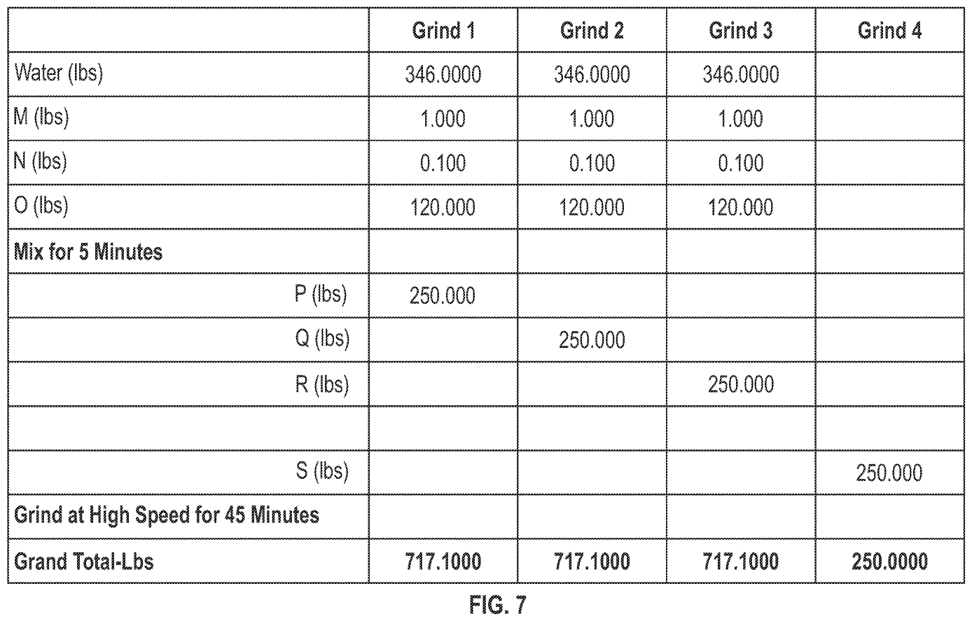

FIG. 7 shows polymer tests with various black pigments. Grinds (e.g., combinations) one, two, and three contain different black pigments. Grind four is used as a control.

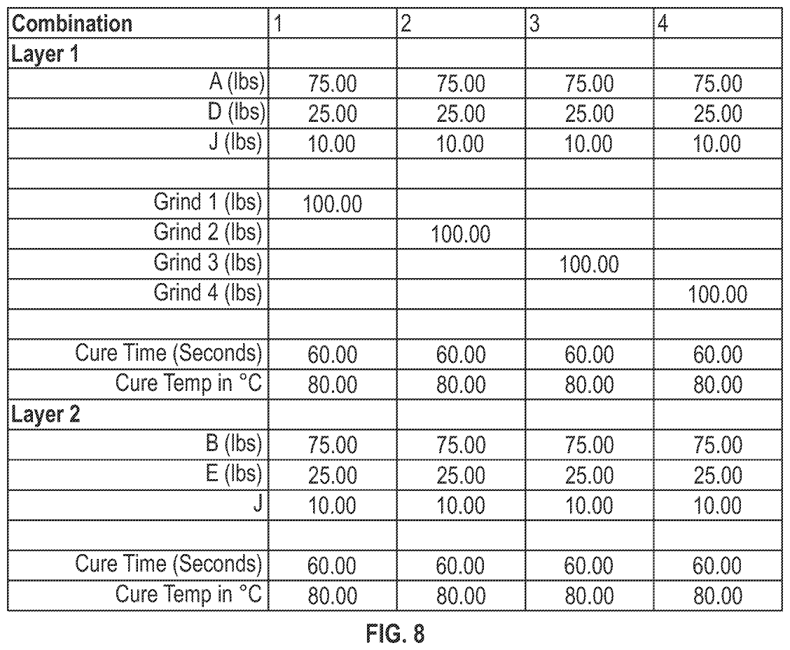

FIG. 8 shows polymer layer tests with various black pigments. Compounds P, Q, and R are the tested black pigments, with compound P yielding the best results.

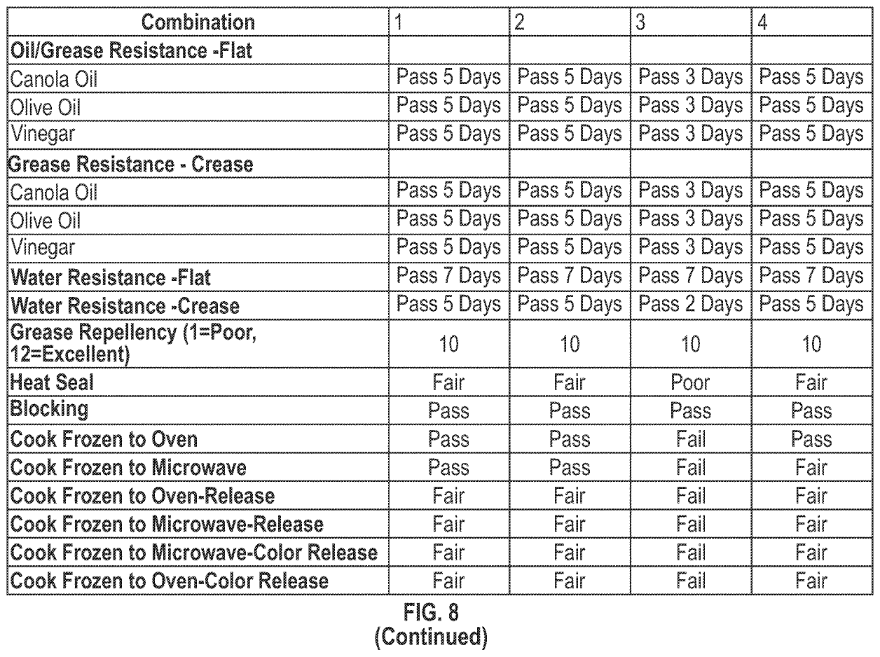

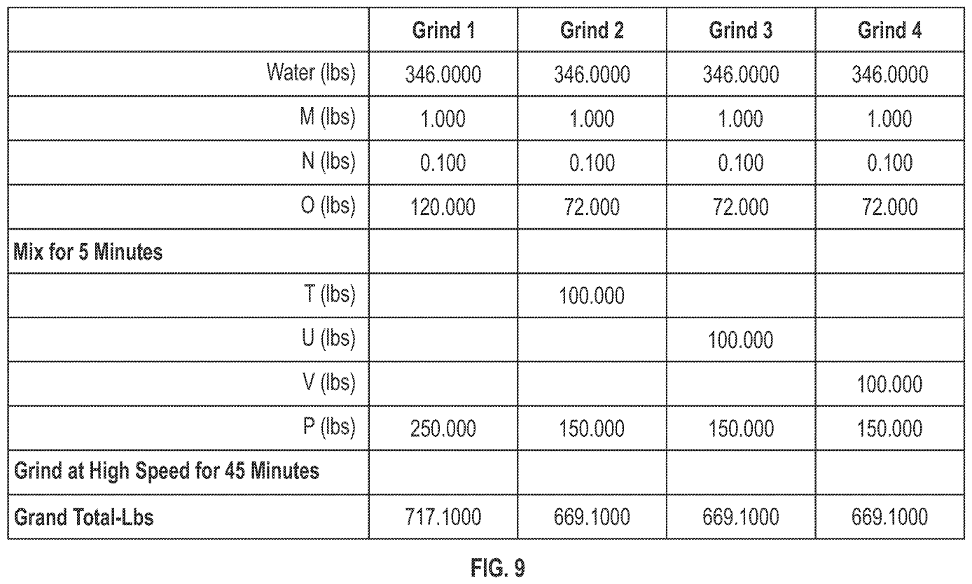

FIG. 9 shows polymer tests with various black pigments with added barrier material.

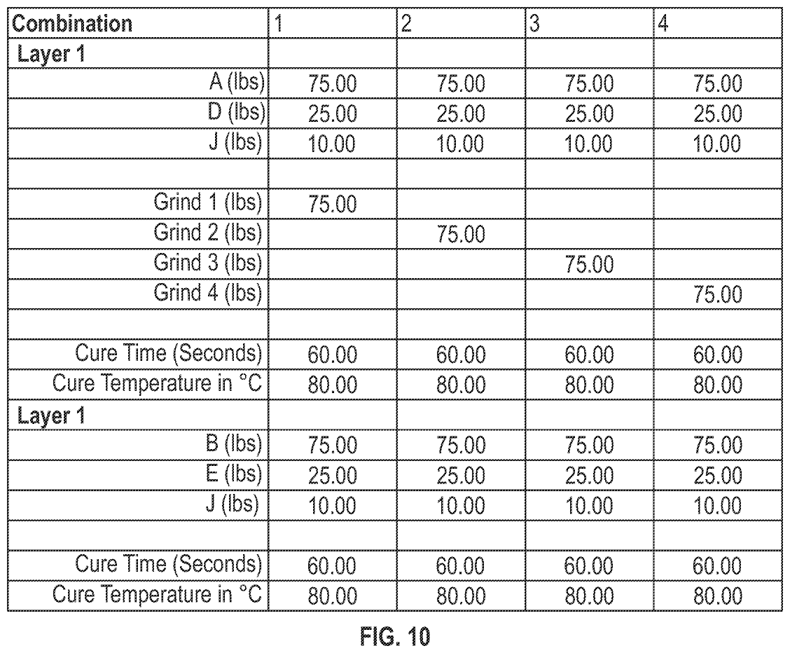

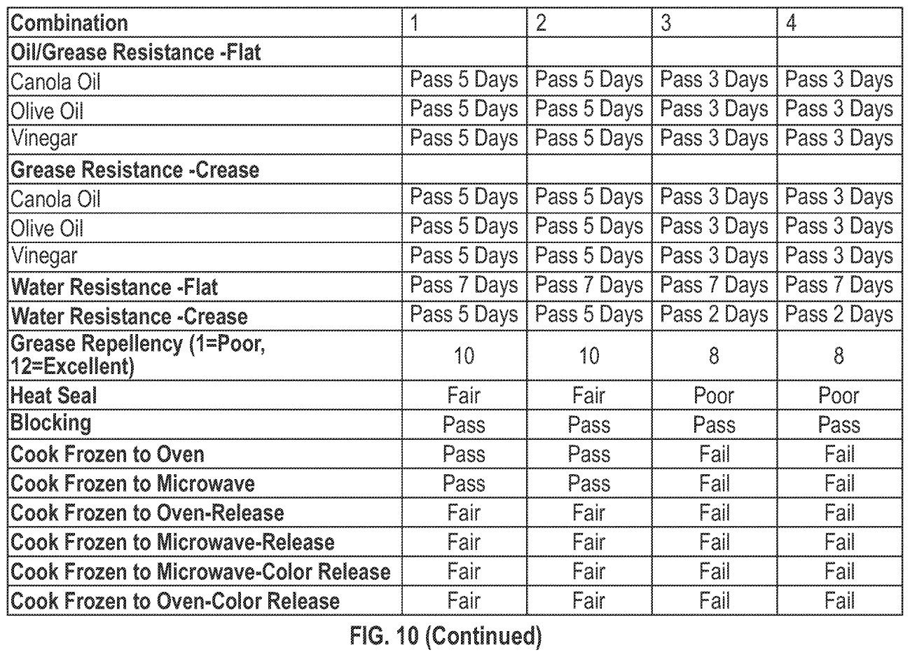

FIG. 10 shows polymer layer tests with various black pigments with added barrier material. Compound T yields the best results.

FIG. 11 shows polymer tests with various black pigments with added barrier material and reduced black pigment.

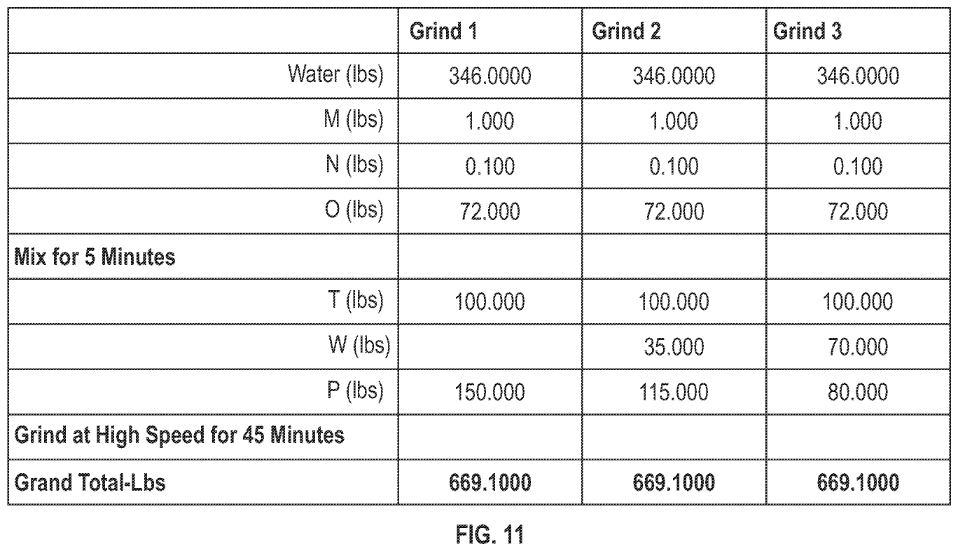

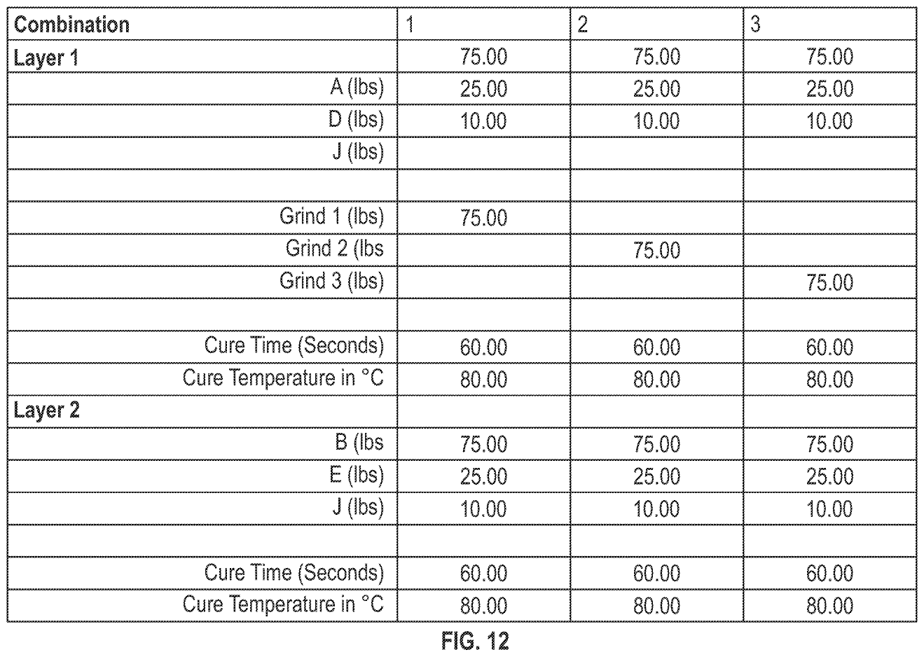

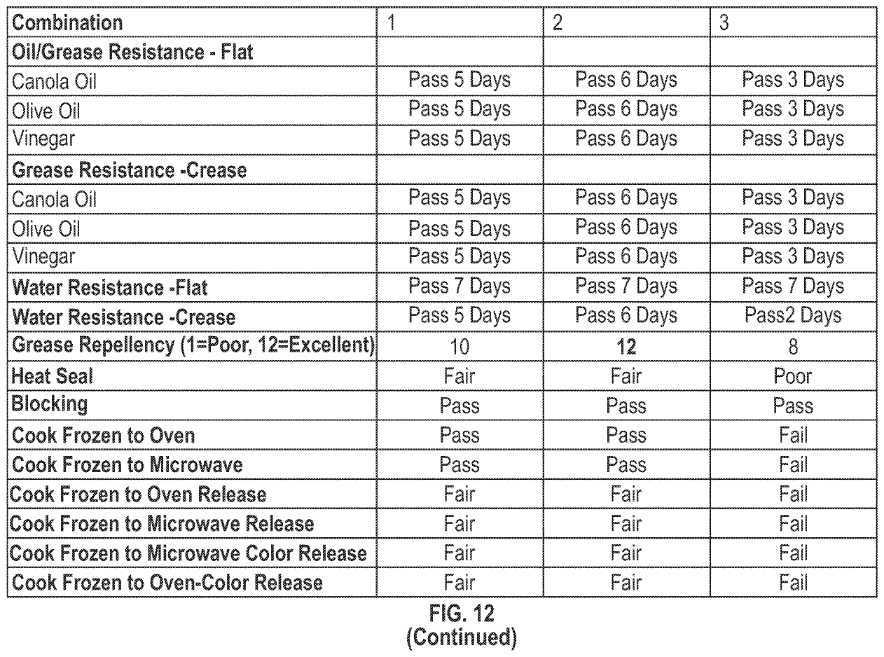

FIG. 12 shows polymer layer tests with various black pigments with added barrier material and reduced black pigment. Thirty-five pounds of compound W yields the best results.

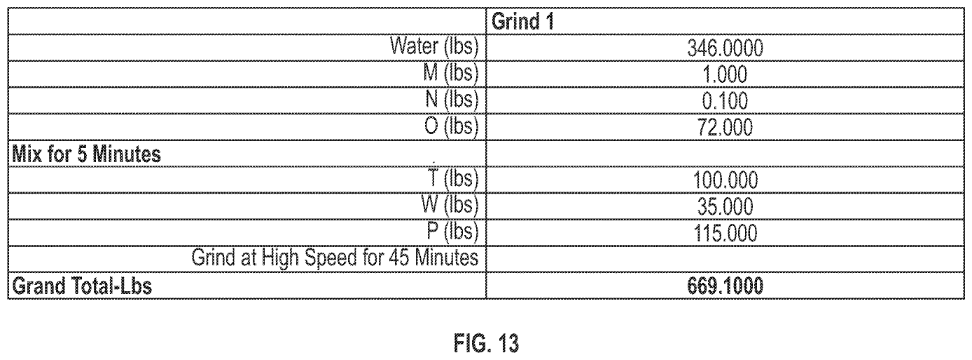

FIG. 13 shows polymer tests with various black pigment amounts.

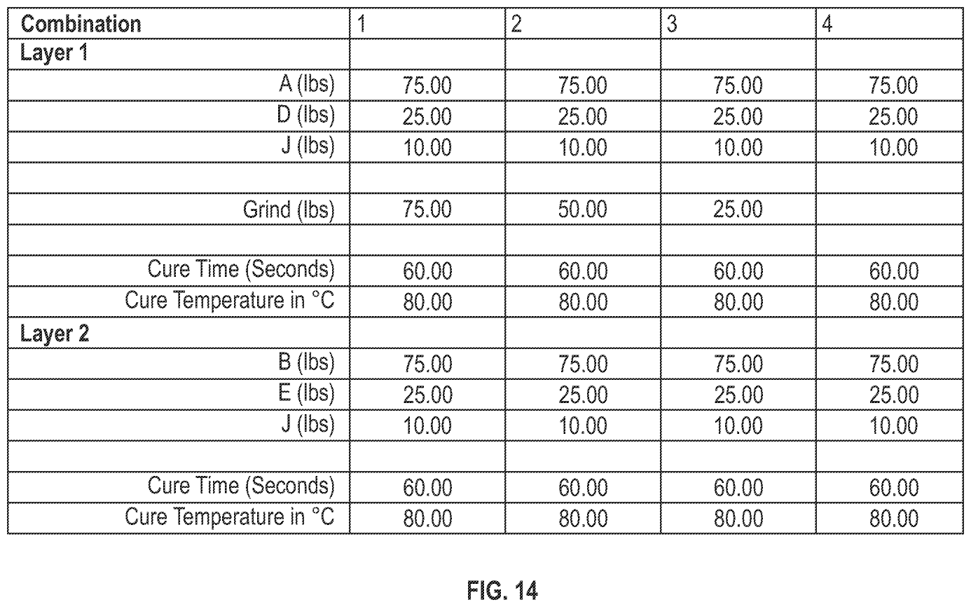

FIG. 14 shows polymer layer tests with various black pigment amounts. Twenty-five pounds of black pigment compounds P, Q, and R yields the best results.

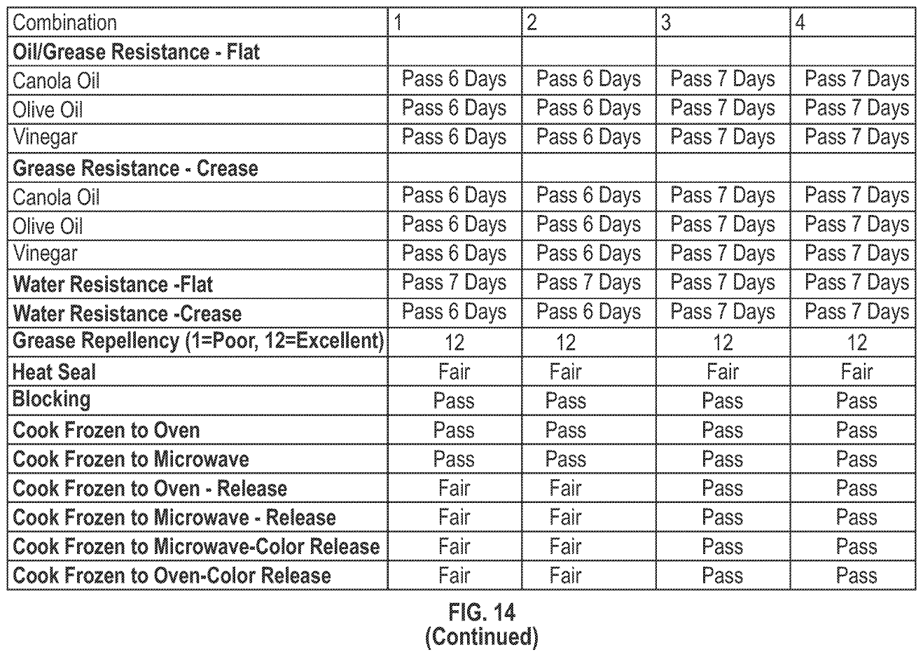

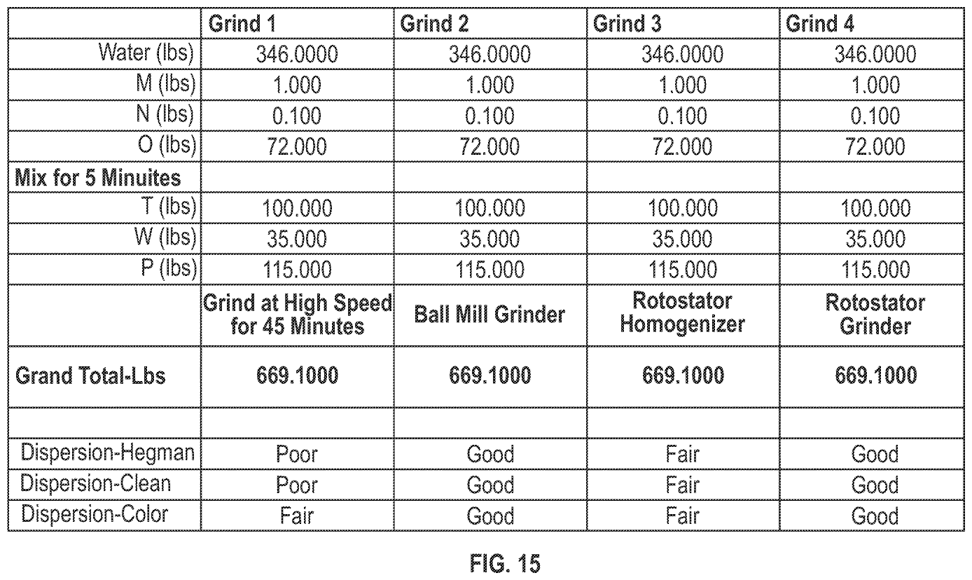

FIG. 15 shows polymer tests with various black pigments with varied dispersions types.

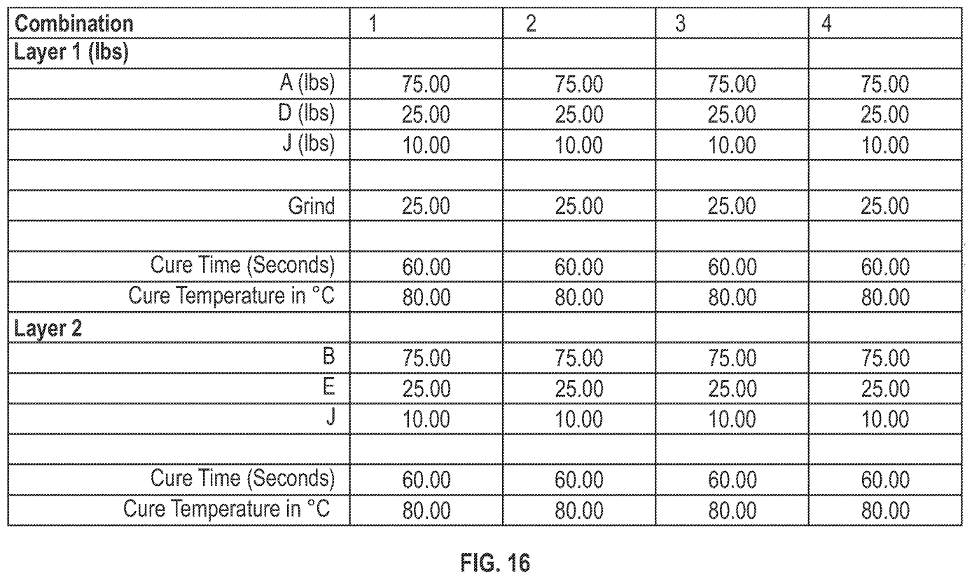

FIG. 16 shows polymer layer tests with various black pigments with varied dispersions types. The rotostator homogenizer and rotostator grinder yield the best results after mixing for five minutes.

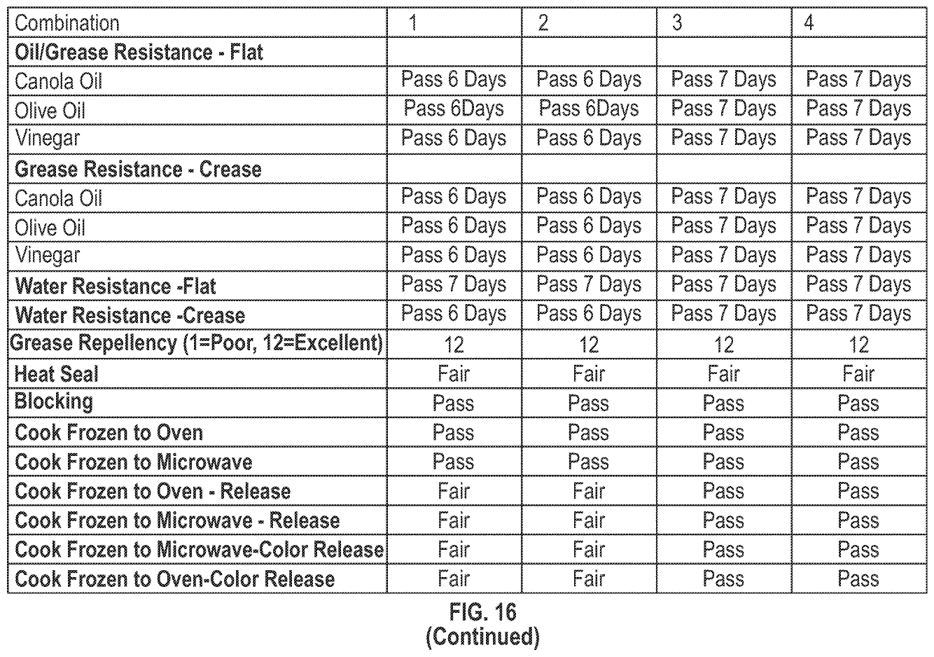

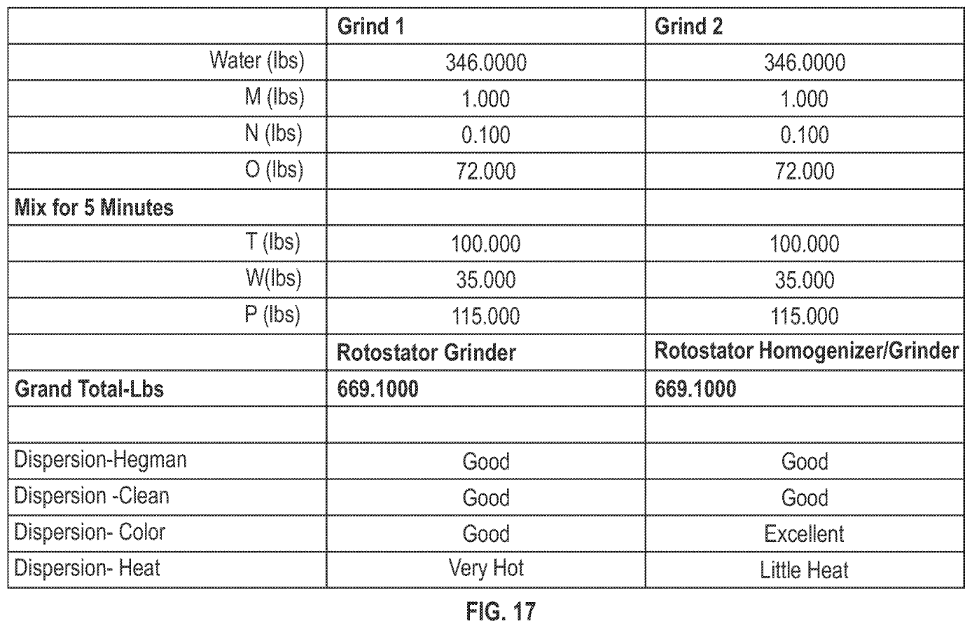

FIG. 17 shows polymer tests with hybrid mixing method.

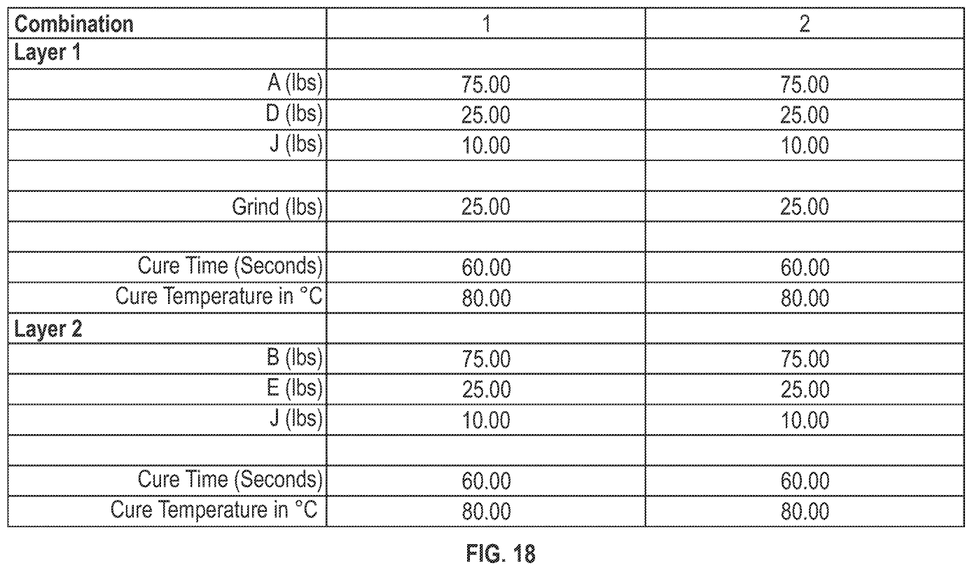

FIG. 18 shows polymer layer tests with hybrid mixing method. The hybrid rotostator and grinder mixing method has improved dispersion performance compared to the conventional rotostator grinder.

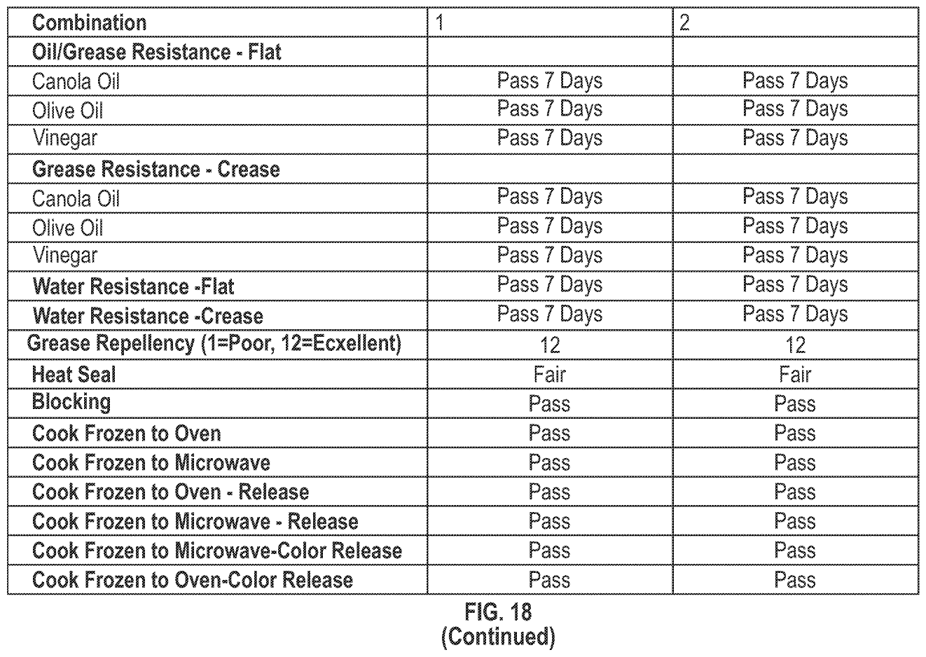

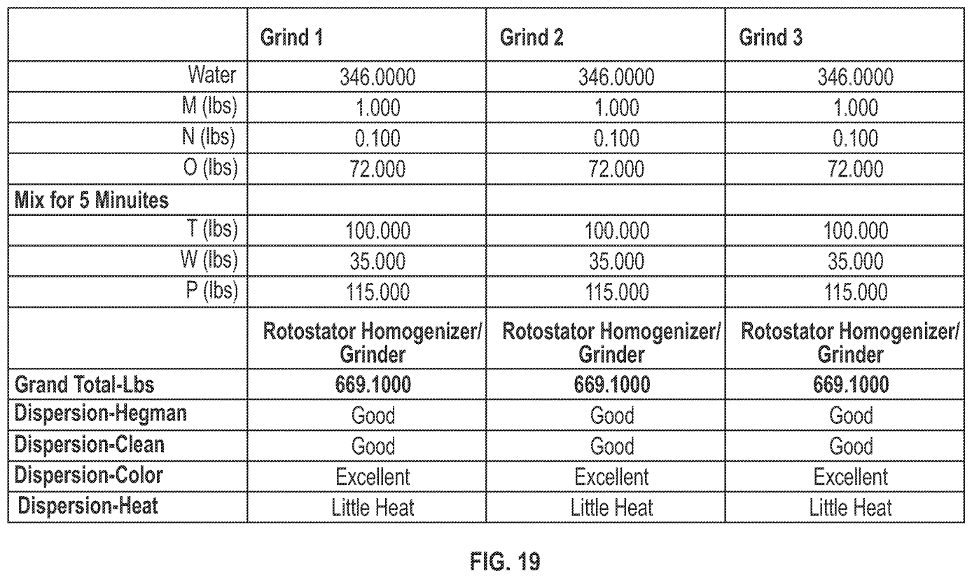

FIG. 19 shows polymer tests with various mixing methods and reduced black pigment amounts. Grind three yields the best results.

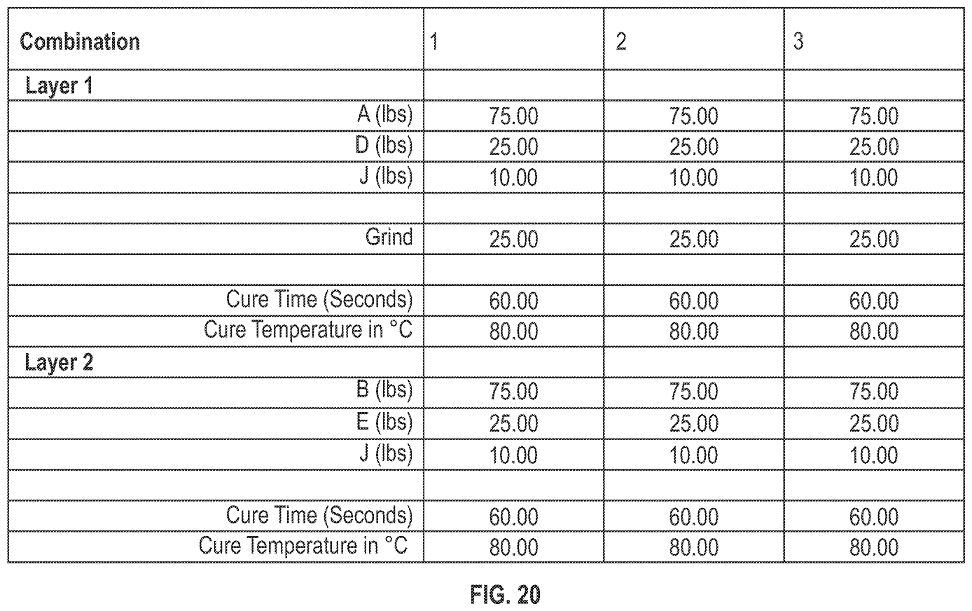

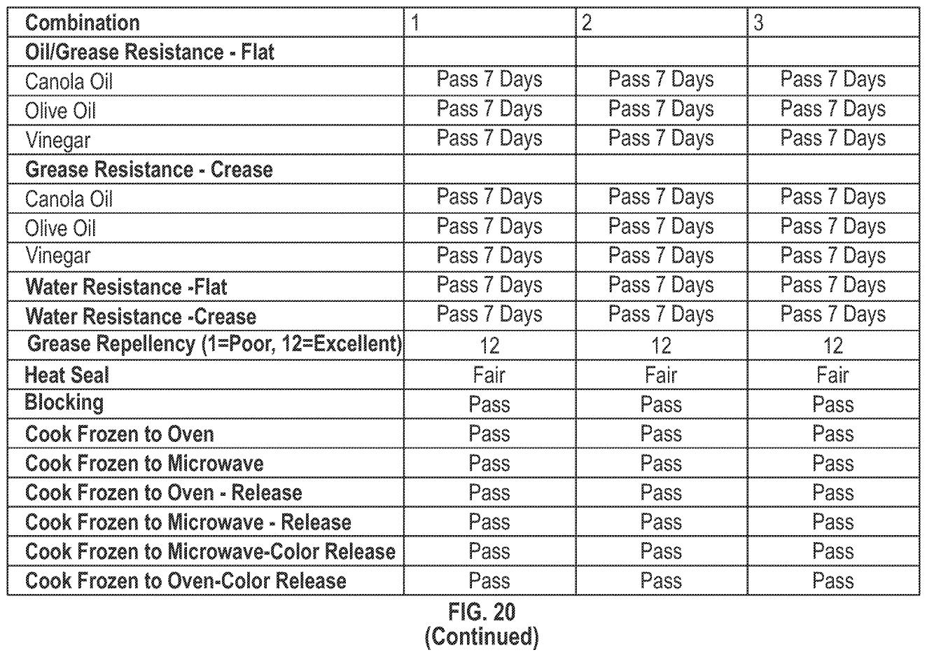

FIG. 20 shows polymer layer tests with various mixing methods and reduced black pigment amounts. Combination three yields the best results.

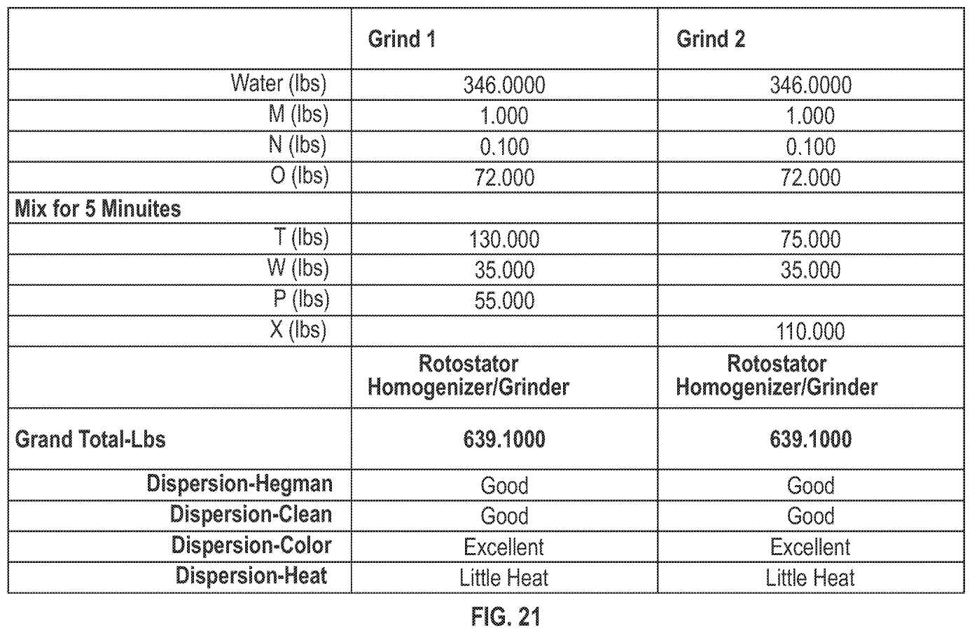

FIG. 21 shows polymer tests with comparing polymers with a clear base, white pigment, and black pigment.

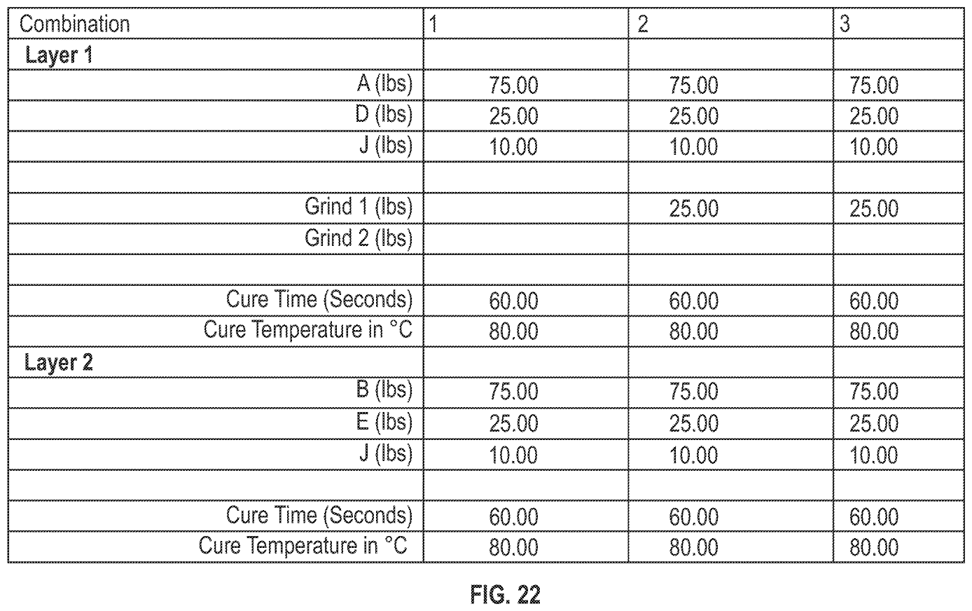

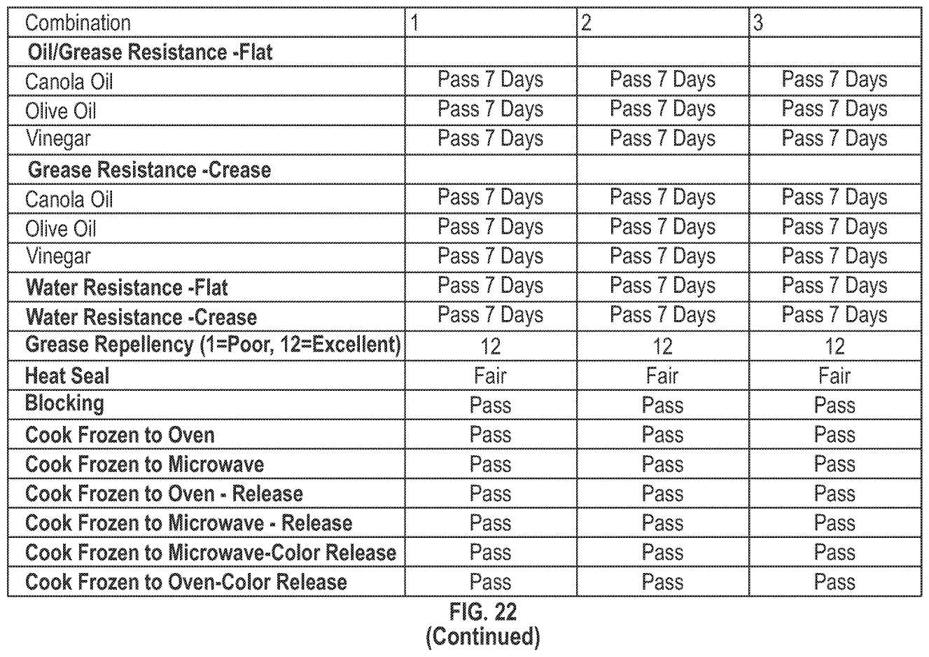

FIG. 22 shows polymer layer tests with comparing polymers with a clear base, white pigment, and black pigment. Grind one, grind two, and grind three show clear base polymer; black pigment dispersion into clear base polymer; and white pigment dispersion into clear base polymer, respectively. Grind two and grind three perform as good as grind one, indicating that the pigments do not interfere with the qualities of the polymer.

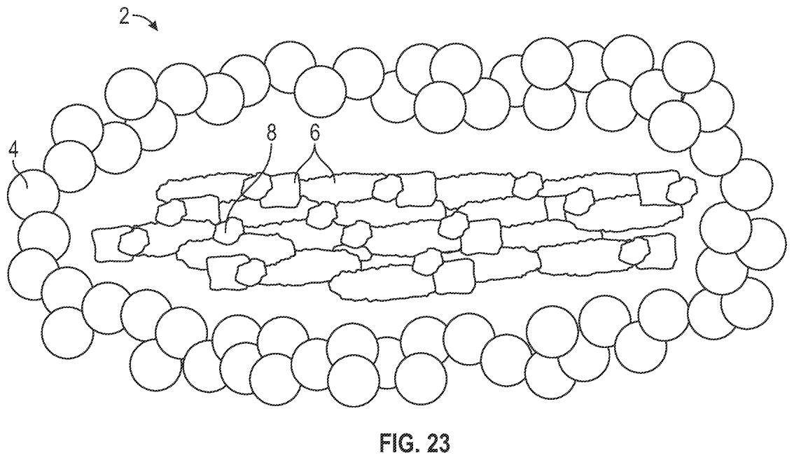

FIG. 23 shows a pigment embedded in a polymer coating. Polymer coating 10 comprises polymer 15, clay 20, and black pigment 25. Polymer molecules 15 are disposed around clay 20 and black pigment 25.

The polymer may comprise an acrylic, copolymer, or a combination thereof. The copolymer may be an emulsion, resin, or a combination thereof. The emulsion may be an acrylic emulsion and the resin may be an acrylic resin. The acrylic may be an emulsion, film-forming, non-film forming, or a combination thereof. The polymer may include, but is not limited to, methyl methacrylic, styrene acrylic, ethyl methacrylic, isobutyl methacrylic, N-butyl methacrylic, ethyl acrylic, ethyl hexyl acrylate, vinyl acrylate, acrylonitrile butadiene acrylate, acrylonitrile acrylate, urethane acrylate, ethylene vinyl acetate acrylic, or a combination thereof. The polymer may be modified with an acrylic and/or a polyvinylidene chloride polymer. Optionally, the polymer comprises a single layer of polyvinylidene chloride polymer.

The polymer may comprise a silane. The silane may comprise an epoxy, an alkoxysilane, an alkylalkoxysilane, or a combination thereof. The silane may be monomeric or an oligomer and may be crosslinked within the polymer. The silane may include, but is not limited to, octyltriethoxysilane, vinyltriethoxysilane, methacryloxy-propyltrimethoxysilane, epoxycyclohexyl-ethyltrimethoxysilane, glycidoxypropyl-trimethoxysilane, aminopropyl-triethoxysilane, aminopropyl-silsesquioxane, isocyanato-propyltriethoxysilane, or a combination thereof. The silane may be crosslinked with another silane.

The polymer may comprise a defoamer. The defoamer may be a polymer and comprise succinic acid, an ester, a polyether, or a combination thereof.

The polymer may comprise a pigment. The pigment may be of any color including, but not limited to, black or white. The pigment may comprise carbon black, titanium dioxide, or a combination thereof. The pigment may add color to the polymer and may not affect the performance and/or functionality of the polymer, e.g., the hydrophobic and oleophobic properties of the polymer

The polymer may comprise a clay. The clay may comprise calcined clay, a calcined surface modified clay, muscovite, kaolin, other transparent clay, or a combination thereof. The clay may be an anhydrous clay, a hydrous spray dry, a hydrous pulverized clay, a delaminated clay, or a combination thereof. The clay may also comprise a modified hydrous surface.

The polymer may comprise a plurality of layers. A first layer may be at least partially disposed on a second layer. The first layer may comprise an acrylic emulsion; a copolymer emulsion, a crosslinked silane, or a combination thereof. The second layer may comprise a copolymer resin, a copolymer emulsion, a crosslinked silane, or a combination thereof. The first and/or second layer may comprise a pigment.

The polymer may comprise a fluoride content of less than about 10 parts per million (PPM), about 9 ppm to about 1 ppm, about 8 ppm to about 2 ppm, about 7 ppm to about 3 ppm, about 6 ppm to about 4 ppm, or about 1 ppm. Optionally, the polymer may not comprise a fluoride atom and/or fluor chemical.

The polymer may have a seal strength of at least about 60° C., about 60° C. to about 120° C., about 70° C. to about 110° C., about 80° C. to about 100° C., or about 120° C. The polymer may have flexibility of at least about 75° C., about 75° C. to about 100° C., about 80° C. to about 95° C., about 85° C. to about 90° C., or about 100° C.

The polymer may be coated onto a surface by rod coating, flexo printing, gravure printing, or a combination thereof. The polymer may comprise a solids content of at least about 40%, about 40% to about 50%, about 44.5% to about 47.5%, about 45% to about 47%, or about 50% by weight. The polymer may have a shelf life of at least about 6 months, about 6 months to 2 years, about 8 months to 1.5 years, about 10 months to 12 months, or about 2 years. The polymer may have a freezing point of about 0° C. and a flash point above 100° C. The polymer may comprise a viscosity of at least about 40 centipoise, about 40 centipoise to about 75 centipoise, about 45 centipoise to about 70 centipoise, about 50 centipoise to about 65 centipoise, about 55 centipoise to about 60 centipoise, or about 75 centipoise. The polymer may comprise a pH of at least about 7.5, about 7.5 to about 9.5, about 8 to about 9, or about 9.5. The polymer may comprise a density of at least about 0.8 grams/milliliter (g/mL), about 0.8 g/mL to about 1.2 g/mL, about 0.9 g/mL to about 1.1 g/mL, or about 1 g/mL. The target dry coating weight of the polymer may be at least about 4 grams per square meter (gsm), about 4 gsm to about 9 gsm, about 5 gsm to about 8 gsm, about 6 gsm to about 7 gsm, or a about 9 gsm.

Embodiments of the present invention provide a technology-based solution that overcomes existing problems with the current state of the art in a technical way to satisfy an existing problem for paper that degrades due to contact with water and/or oil. Embodiments of the present invention achieve important benefits over the current state of the art, such as increased polymer hydrophobicity, oleophobic properties, durability, and longevity. Some of the unconventional steps of embodiments of the present invention include polymerized silanes to improve the hydrophobic and oleophobic properties of the polymer.

The method of making the polymer may comprise curing the polymer and/or compounds thereof. The curing time may be at least about 50 seconds, about 50 seconds to about 120 second, about 60 seconds to about 110 seconds, about 70 seconds to about 100 seconds, about 80 seconds to about 90 seconds, or about 120 seconds. The curing temperature may be at least about 60° C., about 60° C. to about 100° C., about 65° C. to about 95° C., about 70° C. to about 90° C., about 75° C. to about 85° C., or about 100° C.

The method of making the polymer may comprise mixing the polymer and/or compounds thereof. The polymer and/or compounds thereof may be mixed by a rotostator homogenizer, rotostator grinder, a rotostator homogenizer and grinder, ball mill grinder, high speed grinder, or a combination thereof. The mixing may occur for at least about 1 minute, about 1 minute to about 10 minutes, about 2 minutes to about 9 minutes, about 3 minutes to about 8 minutes, about 4 minutes to about 7 minutes, 5 minutes to about 6 minutes, or about 10 minutes. The method of making the polymer may further comprising adding, dispersing, and/or mixing a pigment into the polymer and/or compounds thereof. The dispersion of the pigment may be measured as Hegman, clean, color, head dispersion, or a combination thereof.

Note that in the specification and claims, “about” or “approximately” means within twenty percent (20%) of the numerical amount cited. The terms, “a”, “an”, “the”, and “said” mean “one or more” unless context explicitly dictates otherwise

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A composition comprising:
a first layer comprising:
an acrylic emulsion;
a crosslinked silane;
polyvinylidene chloride;
a second layer comprising:
an acrylic resin;
a crosslinked silane; and
said composition comprising a fluoride content of less than 10 parts per million.

2. The composition of claim 1, wherein said first layer further comprises a defoamer.

3. The composition of claim 2, wherein said defoamer comprises an ester.

4. The composition of claim 1, wherein said second layer further comprises a defoamer.

5. The composition of claim 4, wherein said defoamer comprises an ester.

6. The composition of claim 1, wherein said first layer further comprises a clay.

7. The composition of claim 6, wherein said clay comprises a calcined clay.

8. The composition of claim 1, wherein said second layer further comprises a clay.

9. The composition of claim 8, wherein said clay comprises a calcined clay.

10. The composition of claim 1, wherein said first layer further comprises a pigment.

11. The composition of claim 10, wherein said pigment comprises a calcined clay.

12. The composition of claim 10, wherein said pigment is black.

13. The composition of claim 1, wherein said second layer further comprises a pigment.

14. The composition of claim 13, wherein said pigment comprises a calcined clay.

15. The composition of claim 13, wherein said pigment is black.

16. The composition of claim 1, wherein said polymer comprises a solids content of at least about 40%.

17. A method of making a polymer coating, the method comprising:
mixing a polymer compound to form a mixture, the compound comprising:
a silane;
an acrylic; and
a clay;
applying a first layer of the mixture onto a surface;
crosslinking the silane to form a polymer coating; and
curing the polymer coating.

18. The method of claim 17 further comprising applying a second layer of the mixture onto the first layer of the mixture.

19. The method of claim 17 wherein the curing is performed over of a period of time of between approximately 50 to 120 seconds.

20. The method of claim 17 wherein the curing is performed at a temperature of between approximately 60° C. to 100° C.
